(19) United States
(12) Patent Application Publication
(10) Pub. No.: US 2006/0210846 A1
(43) Pub. Date: Sep. 21, 2006

(54) Carbon monoxide removing method, carbon monoxide removing apparatus, method for producing same, hydrogen generating apparatus using same, and fuel cell system using same

(75) Inventors: Yoshiyuki Isozaki, Nerima-ku (JP); Fuminobu Tezuka, Yokohama-shi (JP); Yoshio Hanakata, Yokohama-shi (JP); Hideo Kitamura, Yokohama-shi (JP); Yuusuke Sato, Bunkyo-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/367,537

(22) Filed: Mar. 6, 2006

(30) Foreign Application Priority Data
Mar. 17, 2005 (JP) 2005-077077

(51) Int. Cl. H01M 8/06; B01J 19/00; B21D 51/16

(52) U.S. Cl. 429/19; 422/198; 29/890

(57) ABSTRACT

A hydrogen generating apparatus and a fuel cell system, which can be reduced in size, are provided. The hydrogen generating apparatus and the fuel cell system each has a CO removing portion. A catalyst portion formed by aluminum is provided on the surface of a CO removing portion for accelerating the methanation reaction of a part of carbon monoxide contained in a reformed gas. The catalyst portion includes a catalyst layer having ruthenium supported on γ-alumina formed by the anodization of the surface thereof. Heating is effected such that the temperature of the catalyst portion reaches 250° C. or more.

The present application claims foreign priority based on Japanese Patent Application No. JP2005-77077 filed on Mar. 17, of 2005, the contents of which is incorporated herein by reference.

### FIELD OF THE INVENTION

The present invention relates to a CO (carbon monoxide) removing method and a CO removing apparatus, and more particularly to a CO removing method and apparatus which can be reduced in size, a method for the production of the CO removing apparatus, a hydrogen generating apparatus using the same and a fuel cell system using the same.

### BACKGROUND OF THE INVENTION

In recent years, there has been developed a fuel cell system comprising in combination a reformer for reforming a light hydrocarbon such as natural gas and naphtha or an alcohol such as methanol in the presence of a reforming catalyst to produce a gas containing hydrogen and a fuel cell having a fuel electrode (anode) into which the reformed gas is supplied and an oxidant electrode (cathode) into which air is supplied. Such a fuel cell system has been given great expectations because it can give a higher output voltage and hence a higher electricity generating efficiency than direct type methanol fuel cells using a liquid fuel such as methanol.

The gas (reformed gas) obtained by reforming an alcohol or dimethyl ether contains carbon dioxide or carbon monoxide in an amount of about 1% as by-products besides hydrogen. Carbon monoxide deteriorates the anode catalyst of the fuel cell stack to cause the deterioration of electricity generating properties. Therefore, a fuel cell system has been developed which uses a CO shifting portion to cause carbon monoxide contained in the gas containing hydrogen which is being supplied from the reforming portion to the fuel cell to be converted to carbon dioxide or uses a CO selective oxidizing portion or CO methanation portion to convert carbon monoxide to carbon dioxide or methane, thereby reducing the concentration of carbon monoxide (JP-A-2002-68707, paragraph (0050)-(0054)).

As a catalyst for reducing the concentration of carbon monoxide there is known one obtained by anodizing aluminum and then supporting palladium thereon (JP-A-2003-119002, paragraph (0023)-(0027)). In JP-A-2003-119002, an equilibrium calculation shows that a reaction vessel using this catalyst allows the methanation of almost all the amount of carbon monoxide in a gas containing carbon monoxide in an amount of about 9 mol-% at a reaction temperature of 280° C.

As a catalyst for reducing the concentration of carbon monoxide there is also known one obtained by anodizing aluminum to form an alumina layer thereon and then supporting any of ruthenium, platinum and rhodium on the alumina layer. When the outlet temperature thereof is set to 150° C. or less, the reaction vessel using this catalyst can be operated with less consumption of hydrogen, making it possible to efficiently reduce the concentration of carbon monoxide (JP-A-2003-340280, paragraph (0002)-(0017)).

However, in order to reduce the concentration of carbon monoxide by oxidizing carbon monoxide contained in the reformed gas, it is necessary that a unit for supplying oxygen into the reformed gas, e.g., air pump be separately provided, causing the rise of the size of the hydrogen generating apparatus and the fuel cell system to disadvantage.

In the case where no hydrogen separating membrane as disclosed in JP-A-2003-119002 is used at a process of methanating carbon monoxide in the presence of a catalyst having palladium supported on anodized aluminum to reduce the concentration of carbon monoxide as disclosed in JP-A-2003-119002, it is considered that hydrogen is consumed by the methanation of carbon dioxide as pointed out in JP-A-2003-340280.

On the other hand, in the case where carbon monoxide is methanated in the presence of a catalyst having any of ruthenium, platinum and rhodium supported on anodized aluminum to reduce the concentration of carbon monoxide as disclosed in JP-A-2003-340280, the consumption of hydrogen as shown in JP-A-2003-119002 is suppressed. However, as pointed out in JP-A-2003-340280, the catalytic activity is considered to be low at 200° C. or less. Accordingly, the capability of the reaction vessel of eliminating carbon monoxide per unit volume is deteriorated. As a result, a larger reaction vessel is needed, causing the rise of the size of the hydrogen generating apparatus and the fuel cell system.

### SUMMARY OF THE INVENTION

According to an illustrative, non-limiting embodiment of the invention, a CO removing apparatus includes: a CO removing portion that removes at least a part of carbon monoxide from a gas containing carbon monoxide, carbon dioxide, and hydrogen, by accelerating the methanation reaction of the at least a part of the carbon monoxide; a catalyst portion in the CO removing portion, the catalyst portion having a surface of one of aluminum and an alloy containing aluminum, the catalyst portion including a catalyst layer containing ruthenium supported by an alumina, the alumina being produced by an anodization of at least a part of the surface; and a heating portion that heats the catalyst portion to a temperature of 250° C. or more.

Further, according to an illustrative, non-limiting embodiment of the invention, an method for producing a CO removing apparatus, which includes: a CO removing portion that removes at least a part of carbon monoxide from a gas containing: carbon monoxide, carbon dioxide, and hydrogen, by accelerating the methanation reaction of the at least a part of the carbon monoxide; a catalyst portion in the CO removing portion, the catalyst portion having a surface of one of aluminum and an alloy containing aluminum including a catalyst layer containing ruthenium supported by an alumina, the alumina being produced by an anodization of at least a part of the surface; and a heating portion that heats the catalyst portion to a temperature of 250° C. or more, includes: anodizing the one of aluminum and an alloy containing aluminum in the catalyst portion to form the alumina; and impregnating the alumina with the ruthenium using an organic salt of ruthenium and an organic solvent to form the catalyst layer.

Moreover, according to an illustrative, non-limiting embodiment of the invention, a CO removing method with a CO removing apparatus, which which includes: a CO removing portion that removes at least a part of carbon monoxide from a gas containing carbon monoxide, carbon dioxide, and hydrogen, by accelerating the methanation reaction of the at least a part of the carbon monoxide; and a catalyst portion in the CO removing portion, the catalyst portion having a surface of one of aluminum and an alloy containing aluminum, the catalyst portion including a catalyst layer containing ruthenium supported by an alumina, the alumina being produced by an anodization of at least a part of the surface, includes heating the catalyst portion to a temperature of 250° C. or more.

Further, according to an illustrative, non-limiting embodiment of the invention, a hydrogen generating apparatus includes: a reforming portion that obtains a reformed gas containing hydrogen from a fuel containing: an organic compound containing carbon, hydrogen, and water; a CO removing portion that removes at least a part of carbon monoxide from the reformed gas by accelerating the methanation reaction of the at least a part of the carbon monoxide; a catalyst portion in the CO removing portion, the catalyst portion having a surface of one of aluminum and an alloy containing aluminum, the catalyst portion including a catalyst layer containing ruthenium supported by an alumina, the alumina being produced by an anodization of at least a part of the surface; and a heating portion that heats the catalyst portion to a temperature of 250° C. or more.

Moreover, according to an illustrative, non-limiting embodiment of the invention, a fuel cell system includes: a reforming portion that obtains a reformed gas containing hydrogen from a fuel containing: an organic compound containing carbon, hydrogen, and water; a CO removing portion that removes at least a part of carbon monoxide from the reformed gas by accelerating the methanation reaction of the at least a part of the carbon monoxide; a catalyst portion in the CO removing portion, the catalyst portion having a surface of one of aluminum and an alloy containing aluminum, the catalyst portion including a catalyst layer containing ruthenium supported by an alumina, the alumina being produced by an anodization of at least a part of the surface; a heating portion that heats the catalyst portion to a temperature of 250° C. or more; and a fuel cell that generates electricity from the hydrogen by the reforming reaction (i.e., the hydrogen in the reformed gas) and oxygen in the atmosphere.

### BRIEF DESCRIPTION OF THE DRAWINGS

FIG. 1 is a diagram illustrating a first exemplary embodiment of a fuel cell system according to the invention.

FIG. 2 is an exploded perspective view illustrating a part of the first embodiment of the fuel cell system according to the invention.

FIG. 3 is an enlarged sectional view illustrating a part of the first embodiment of the fuel cell system according to the invention.

FIGS. 4A and 4B are sectional views illustrating another embodiment of a catalyst portion in the first embodiment of the fuel cell system according to the invention.

FIG. 5 is an enlarged sectional view illustrating the example shown in FIG. 4B.

FIG. 6 is a perspective view illustrating a second exemplary embodiment of a fuel cell system according to the invention.

FIG. 7 is an exploded perspective view illustrating a part of a third exemplary embodiment of the fuel cell system according to the invention.

FIG. 8 is a graph illustrating examples of a fuel cell system according to the invention.

FIG. 9 is a graph illustrating examples of a fuel cell system according to the invention.

FIG. 10 is a graph illustrating examples of a fuel cell system according to the invention.

FIG. 11 is a graph illustrating examples of a fuel cell system according to the invention.

### DETAILED DESCRIPTION OF THE INVENTION

Exemplary embodiments of the invention will be described hereinafter in connection with the attached drawings.

(First Embodiment)

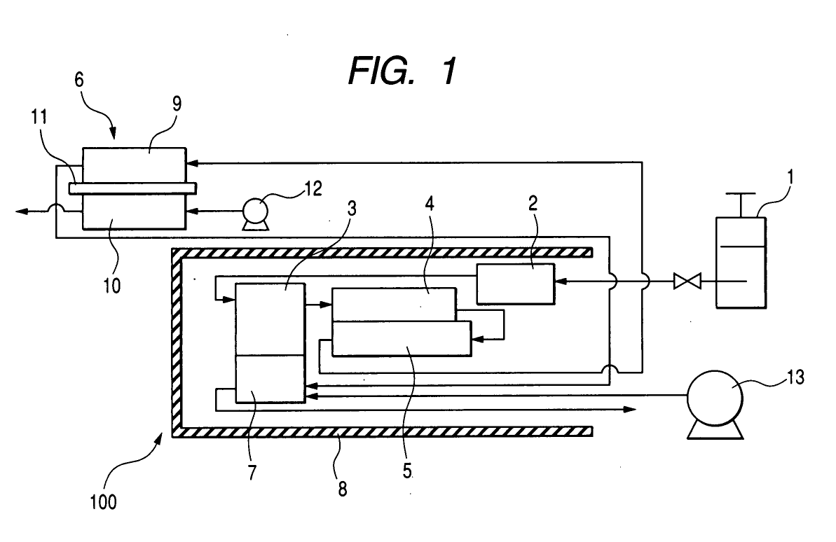

FIG. 1 illustrates a first exemplary embodiment of a CO removing apparatus according to the invention and a fuel cell system using the same.

The fuel cell system includes a hydrogen generating apparatus 100 and a fuel cell 6.

The hydrogen generating apparatus 100 includes a fuel supplying unit 1. The fuel supplying unit 1 has a mixture of an organic compound containing carbon and hydrogen as a fuel for the fuel cell system and water stored therein. As a fuel there may be used a mixture of dimethyl ether and water or a mixture of dimethyl ether, water and an alcohol. As such an alcohol there is preferably used methanol, ethanol or the like. In particular, methanol is preferably used because the mutual solubility of dimethyl ether and water can be enhanced.

As the fuel supplying unit 1 there may be used, e.g., a pressure vessel attached detachably to the fuel cell system. The fuel can be supplied into the vaporization portion 2 described later by making the use of the pressure of dimethyl ether.

Stoichiometrically speaking, the ideal mixing ratio (molar) of dimethyl ether to water is 1:3. In the actual fuel cell system, however, when the mixing ratio of dimethyl ether to water is close to 1:3, the produced amount of carbon monoxide increases. Further, since extra water can be used for shift reaction or electricity generation described later, the mixing ratio of dimethyl ether to water is preferably 1:3.5 or more. However, in order to prevent the rise of the energy required to heat and vaporize the fuel in the vaporization portion 2 described later, the mixing ratio of dimethyl ether to water is preferably 1:5.0 or less, ideally 1:4.0 or less.

The hydrogen generating apparatus 100 includes a vaporization portion 2. The vaporization portion 2 is connected to the fuel supplying unit 1 through a piping or the like. The fuel which has been supplied into the vaporization portion 2 is then heated and vaporized.

The hydrogen generating apparatus 100 includes a reforming portion 3. The reforming portion 3 is connected to the vaporization portion 2 through a piping or the like. The fuel which has been supplied into the reforming portion 3 and vaporized is then reformed in the reforming portion 3 to form a gas containing hydrogen (reformed gas). Inside the reforming portion 3 is provided a channel through which the vaporized fuel flows. On the inner wall of the channel is provided a reforming catalyst for accelerating the reforming reaction of the vaporized fuel to a reformed gas.

The hydrogen generating apparatus 100 may have a CO shifting portion 4 provided therein. The CO shifting portion 4 is connected to the reforming portion 3 through a piping or the like. The reformed gas which has been formed in the reforming portion 3 and then passed to the CO shifting portion 4 contains carbon monoxide and carbon dioxide as by-products besides hydrogen. Carbon monoxide deteriorates the anode catalyst of the fuel cell to cause the deterioration of the electricity generating properties of the fuel cell system. It is thus preferred that the CO shifting portion 4 be provided to cause a reaction for shifting carbon monoxide to carbon dioxide before supplying the gas containing hydrogen from the reforming portion 3 into the fuel cell 6 to raise the produced amount of hydrogen. Inside the CO shifting portion 4 is provided a channel through which the reformed fuel passes. On the inner wall of the channel is provided a shifting catalyst for accelerating the shifting reaction of carbon monoxide contained in the reformed gas.

In the hydrogen generating apparatus 100 is provided a CO removing portion 5 (CO removing apparatus). The CO removing portion 5 is connected to the CO shifting portion 4 through a piping or the like. The reformed gas (gas to be processed) which has been formed by shifting reaction in the CO shifting portion 4 and then passed to the CO removing portion 5 still contain carbon monoxide in an amount of 1.0 mol-% or less. As previously mentioned, carbon monoxide causes the deterioration of the electricity generating properties of the fuel cell system. In order to prevent this trouble, the CO removing portion 5 operates to cause methanation reaction for converting carbon monoxide to methane and water to remove carbon monoxide until the concentration of carbon monoxide reaches 100 ppm by mole before supplying the gas containing hydrogen from the reforming portion 3 into the fuel cell 6. Inside the CO removing portion 5 is provided a catalyst portion 22 for accelerating the methanation reaction of carbon monoxide contained in the reformed gas.

The fuel cell 6 is connected to the CO removing portion 5 through a piping or the like. The reformed gas freed of carbon monoxide is then passed to the fuel cell 6. The fuel cell 6 operates to cause the reaction of hydrogen in the reformed gas with oxygen in the atmosphere supplied using a pump 12. By this reaction, the fuel cell 6 generates electricity while producing water. In order to supply atmosphere into the fuel cell 6, the pump 12 is provided.

The hydrogen generating apparatus 100 includes a combustion portion 7 (heating portion) provided therein. The combustion portion 7 is connected to the fuel cell 6 through a piping or the like. In the fuel cell 6, hydrogen and oxygen react to produce water. The exhaust gas discharged from the fuel cell 6 contains unreacted hydrogen. The combustion portion 7 operates to cause the combustion of the unreacted hydrogen with oxygen in the atmosphere supplied using the pump 13.

During this procedure, the combustion heat generated during combustion is utilized to heat the vaporization portion 2, the reforming portion 3, the CO shifting portion 4 and the CO removing portion 5. In order to uniformalize the heating efficiency and heating temperature and protect ambient parts having a low heat resistance such as electronic circuit, the periphery of the vaporization portion 2, the reforming portion 3, the CO shifting portion 4, the CO removing portion 5 and the combustion portion 7 is covered by a heat insulation portion 8. Since the heat required to cause reforming reaction in the reforming portion 3 is greater than that required for the vaporization portion 2, the CO shifting portion 4 and the CO removing portion 5, the reforming portion 3 is preferably brought into contact with the combustion portion 7 or formed integrally with the combustion portion 7 so that the combustion heat can be efficiently transferred from the combustion portion 7 to the reforming portion 3.

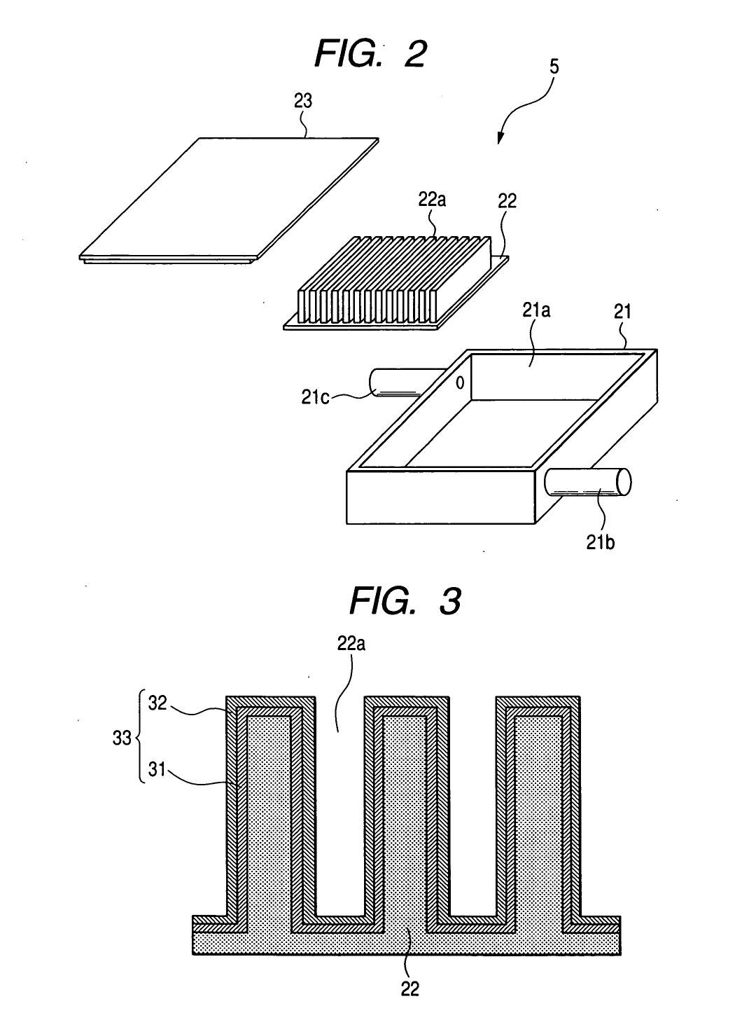

The CO removing portion 5 will be further described hereinafter. FIG. 2 depicts an exploded perspective view of the CO removing portion 5. The CO removing portion 5 comprises a vessel 21, a catalyst portion 22 and a lid 23.

The vessel 21 is formed by working a matrix. In order to enhance the heat transfer properties during the catalytic reaction, at least a part of the matrix is preferably a material having a high heat conductivity. In particular, aluminum, copper, aluminum alloy or copper alloy exhibits not only a high heat conductivity but also an excellent workability and thus can be used to form the vessel 21. In the case where the hydrogen generating apparatus is expected to be used over an extended period of time, a stainless alloy, too, is preferred because it doesn't exhibit so high a heat conductivity as aluminum alloy or copper alloy but exhibits an excellent corrosion resistance.

The vessel 21 has a fitting portion 21a provided therein in which the catalyst portion 22 is fitted. The lid 23 described later is then provided on the vessel 21 in which the catalyst portion 22 is fitted. In necessary, the fitting portion 21a is formed in such an arrangement that the catalyst portion 22 and the vessel 21 or the vessel 21 and the lid 23 are bonded to each other to seal the fitting portion 21a and form a channel. The shape of the channel thus formed may be parallel as shown in FIG. 2 or serpentine.

The catalyst portion 22 is formed by working a matrix. At least a part of the matrix of the catalyst portion 22 may be aluminum or an alloy containing aluminum.

The catalyst portion 22 includes penetration grooves 22a provided therein. A plurality of penetration grooves 22a are provided on one side of the catalyst portion 22 in such an arrangement that they pass through one end to the other. The penetration grooves 22a are provided adjacent to each other. In order to suppress the dispersion of the temperature of the reformed gas flowing through the penetration grooves 22a, the width of the penetration grooves 22a (the wide between two penetration grooves adjacent to each other) is preferably 1 mm or less. The penetration grooves 22a are preferably formed by subjecting the matrix of the catalyst portion 22 to ordinary mechanical working process or molding process.

Examples of ordinary mechanical working process include discharge working using wire (wire cutting). Wire cutting involves discharge working with the movement of a fine metal wire as a tool electrode or an object to be worked according to a desired shape. Besides wire cutting, abrasive grain working may be effected using a blade formed by fixing a particulate abrasive made of diamond or the like into a disc with a resin. In accordance with abrasive grain working, the blade is moved in contact with the object to be worked while being rotated at a high speed so that the object is abraded and removed by the abrasive grain at the area where the blade runs to form a desired shape. Wire cutting or abrasive grain working is very suitable for the formation of penetration grooves such as penetration groove 22a in a short period of time.

Examples of ordinary molding process include forging. Forging is a working process which comprises giving a forging effect to a rod-shaped or bulk metal material under pressure using a tool to form the metal material into a desired shape while improving the mechanical properties thereof Besides forging, casting may be effected. In accordance with casting, a molten metal is injected into a mold having a desired hollow shape. After cooling, the mold is removed to obtain a desired shape. Forging and casting are very suitable for the formation of a complicated shape such as catalyst portion 22.

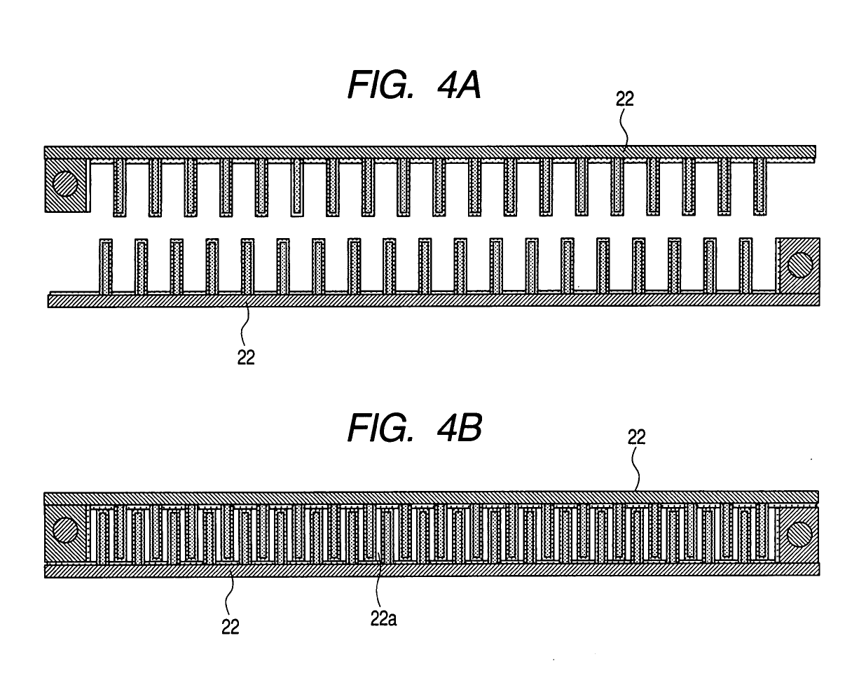

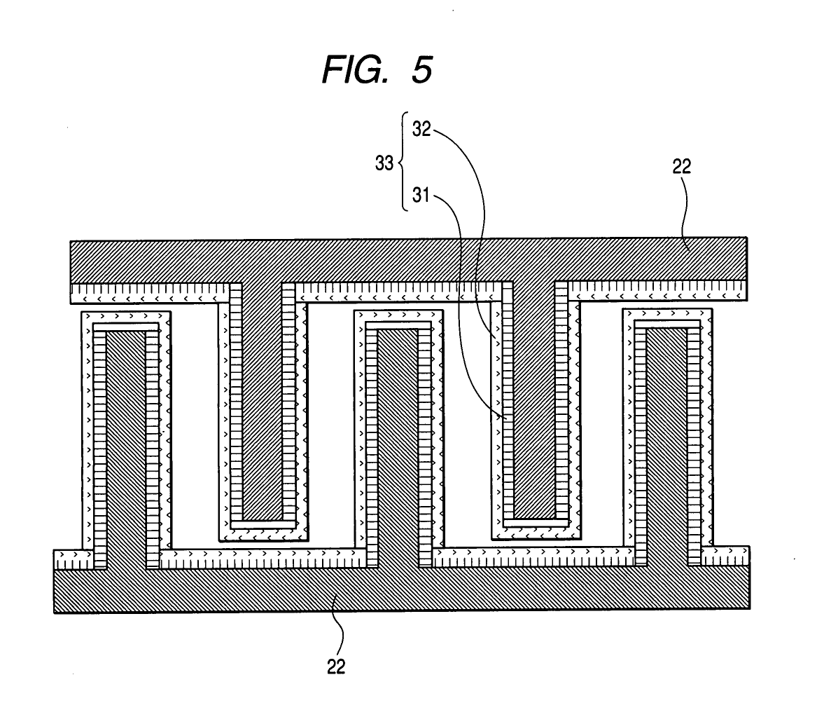

FIGS. 4A and 4B are sectional views illustrating another embodiment of a catalyst portion in this embodiment, and FIG. 5 is an enlarged sectional view illustrating the example shown in FIG. 4B. In this embodiment, two catalyst portions 22 having common structure are combined as shown in FIGS. 4A, 4B and 5.

On the wall of the penetration grooves 22a is provided the catalyst layer 33. The catalyst layer 33 will be further described later.

On the vessel 21 in which the catalyst portion 22 is fitted is provided the lid 23. The lid 23 is provided to seal the fitting portion 21a. As the lid 23 there may be used a sheet-shaped member at least a part of which is made of a material having a high heat conductivity. Examples of the material having a high heat conductivity include aluminum, copper, aluminum alloy, and copper alloy. In the case where the channel structure is expected to be used over an extended period of time, a stainless alloy, too, can be used because it doesn't exhibit so high a heat conductivity as aluminum alloy or copper alloy but exhibits an excellent corrosion resistance.

The lid 23 is provided on the vessel 21 in such an arrangement that the opening of the vessel 21 except a feed port 21b and a discharge port 21c described later is covered. The lid 23 provided on the vessel 21 seals the fitting portion 21a to form a channel with the feed port 21b as inlet and the discharge portion 21c as outlet. In some detail, when the fitting portion 21a is sealed by the lid 23, a channel is formed in such an arrangement that the fluid which has been supplied through the feed port 21b passes through the penetration grooves 22a until it is discharged through the discharge portion 21c.

The vessel 21 includes the feed port 21b and the discharge portion 21c provided connecting to the fitting portion 21a. By sealing the fitting portion 21a in which the catalyst portion 22 has been fitted with the lid 23, the CO removing portion 5 having a parallel channel with the feed port 21b as inlet and the discharge portion 21c as outlet is formed.

Inside the CO removing portion 5 is provided a parallel channel or serpentine-shaped channel as previously mentioned. On the inner wall of the channel is provided the catalyst layer 33.

The reformed gas which has passed through reforming reaction in the reforming portion 3, shifting reaction in the CO portion and then be passed to the CO removing portion 5 contains carbon dioxide and carbon monoxide as by-products besides hydrogen. As previously mentioned, carbon monoxide deteriorates the anode catalyst of the fuel cell to cause the deterioration of the electricity generating properties of the fuel cell. In order to prevent this trouble, the CO removing portion 5 operates to cause the methanation of carbon monoxide in the CO removing portion 5 as shown by the following formula (1) before supplying a gas containing hydrogen from the reforming portion 3 into the fuel cell 6 to remove carbon monoxide until the concentration of carbon monoxide reaches 100 ppm by mole or less.
CO+3H₂→CH₄+H₂O (1)

The catalyst layer 33 will be described hereinafter. FIG. 3 depicts an enlarged sectional view of the catalyst layer 33. The catalyst layer 33 has at least ruthenium 32 and optionally other additives supported on the surface of an alumina layer 31. The alumina layer 31 can be formed by anodizing the surface of the aluminum portion of the catalyst portion 22.

The alumina layer 31 will be further described hereinafter. When the catalyst portion 22 is anodized with an acidic aqueous solution or alkaline aqueous solution, the alumina layer 31 is formed on the surface of the aluminum portion of the catalyst portion 32. Thereafter, if necessary, the alumina layer 31 is processed with an acidic aqueous solution to widen the micropores formed thereon, and then subjected to hydration. The catalyst portion 22 is then optionally calcined at a temperature of 350° C. or more, preferably from 450° C. to 550° C. for 1 hour or more. When thus calcined, the alumina layer 31 becomes γ-alumina (γ-Al₂O₃).

The thickness of the alumina layer 31 is preferably from not smaller than 30 μm to not greater than 100 μm. This is because when the thickness of the alumina layer 31 falls below 30 μm or exceeds 100 μm, the resulting percent utilization of catalyst is lowered. The alumina layer 31 has a large number of micropores present in the surface thereof. The anodization and subsequent processing with an acidic aqueous solution are preferably effected under the conditions such that the average diameter of micropores is from not smaller than 5 nm to not greater than 10 nm. When the average diameter of micropores falls within the above defined range, the selectivity of the reaction represented by the formula (1) with respect to methanation reaction of carbon dioxide represented by the following formula (2) can be enhanced.
CO₂+4H₂→CH₄+2H₂O (2)

Ruthenium (Ru) 32 will be further described hereinafter. As previously mentioned, the alumina layer 31 has a large number of micropores present in the surface thereof The alumina layer 31 having micropores is then subjected to an ordinary processing step such as impregnation method and wash coating method so that ruthenium 32 is supported thereon.

Among known catalyst supporting methods, an impregnation method will be described hereinafter by way of example. Using an organic salt of ruthenium such as ruthenium acetyl acetonate (Ru(C₅H₇O₂)₃) and an organic solvent such as acetone (CH₃COCH₃), acetylacetone (CH₃COCH₂COCH₃) and tetrahydrofurane ((CH₂)₃CH₂O), the alumina layer 31 can be impregnated with ruthenium 32. Alternatively, an aqueous solution of ruthenium chloride may be used to impregnate the alumina layer 31 with ruthenium 32. However, since ruthenium chloride (RuCl₃.nH₂O) has a high acidity, the aluminum portion under the alumina layer 31 and ruthenium chloride react with each other, occasionally causing the exfoliation of the alumina layer 31. Accordingly, taking into account yield or process margin, an organic salt of ruthenium and an organic solvent are preferably used to impregnate the alumina layer 31 with ruthenium 32.

The conditions under which CO is removed in the CO removing portion 5 will be described hereinafter. As previously mentioned, the concentration of carbon monoxide in the reformed gas from which carbon monoxide is to be removed in the CO removing portion 5 is preferably 1.0 mol-% or less. In some detail, in order to suppress the production of carbon monoxide during the reforming reaction or accelerate the shifting reaction of carbon monoxide produced during the reforming reaction, additives may be added to the reforming catalyst provided in the reforming portion 3. Instead of or at the same time with the addition of additives to the reforming catalyst, the CO shifting portion 4 may be provided as previously mentioned.

Further, the CO removing portion 5 is heated by the combustion portion 7 such that the temperature of the catalyst portion 22 reaches 250° C. or more. During this procedure, the temperature of the catalyst portion 22 can be measured by a temperature sensor provided inside the CO removing portion 5. However, since the width of the penetration grooves 22a provided in the catalyst portion 22 is as small as 1 mm or less as previously mentioned, it is occasionally difficult to provide the temperature sensor inside the CO removing portion 5. In this case, the temperature of the catalyst portion 22 is indirectly measured by a temperature sensor provided on the outer wall of the CO removing portion 5.

Subsequently, the fuel cell 6 will be further described hereinafter. The fuel cell 6 comprises a protonically-conductive electrolyte membrane 11 made of a fluorocarbon polymer having a cation exchange group such as sulfonic acid group and carboxylic acid group, e.g., Nafion (trade name of product of Du Pont) provided interposed between a fuel electrode (anode) 9 made of a porous sheet having a carbon powder-supported Pt retained on a water-repellent resin binder such as polytetrafluoroethylene (PTFE) and an oxidant electrode (cathode) 10 made of a porous sheet having a carbon powder-supported Pt retained on a water-repellent resin binder such as polytetrafluoroethylene (PTFE). This porous sheet may contain a sulfonic acid-based perfluorocarbon polymer or particles covered by this polymer.

Hydrogen which has been supplied into the fuel electrode 9 undergoes reaction on the fuel electrode 9 as follows.
H₂→2H⁺+2e⁻ (3)
On the other hand, oxygen which has been supplied into the oxidant electrode 10 undergoes reaction on the oxidant electrode 10 as follows.
½O₂+2H⁺+2e⁻→H₂O (4)

The combustion portion 7 will be further described hereinafter. Inside the combustion portion 7 is provided a serpentine-shaped or parallel channel through which the fuel used in electricity generation flows. On the inner wall of the channel is provided a combustion catalyst such as alumina having a noble metal such as Pt and Pd, optionally in combination, supported thereon. The reason why such a noble metal is used is to prevent the oxidation or deterioration of the combustion catalyst during the suspension of the operation of the fuel cell without any additional facilities for preventing the oxidation or deterioration of the catalyst.

In accordance with the hydrogen generating apparatus and fuel cell system thus prepared, the concentration of carbon monoxide contained in the reformed gas can be fully reduced by a small-sized CO removing portion 5. In some detail, the hydrogen generating apparatus and the fuel cell system can be reduced in size without deteriorating the catalyst of the fuel electrode 9 and hence the electricity generating properties.

Further, the selectivity of methanation reaction of carbon monoxide with respect to methanation reaction of carbon dioxide in the CO removing portion 5 is high. Accordingly, the amount of hydrogen to be consumed by the methanation reaction of carbon dioxide during the removal of carbon monoxide in the CO removing portion 5 can be reduced. In other words, the hydrogen generating efficiency of the entire hydrogen generating apparatus can be enhanced to enhance the electricity generating efficiency of the fuel cell system.

Moreover, since the CO removing portion 5 uses methanation reaction to remove carbon monoxide, it is not necessary that oxygen be supplied to the CO removing portion 5. Accordingly, it is not necessary that the CO removing portion 5 have a unit for supplying oxygen such as pump provided therein. Thus, the hydrogen generating apparatus and the fuel cell system can be reduced in size.

In the case where a fuel containing dimethyl ether is used, even when by-products other than carbon monoxide and carbon dioxide produced with the reforming reaction of unreformed dimethyl ether or dimethyl ether are passed to the CO removing portion, the catalyst layer 33 having ruthenium supported on alumina formed by anodization exhibits a high resistance to these by-products, making it possible to remove carbon monoxide stably over an extended period of time.

While the foregoing description has been made with reference to the case where the reforming portion 3 has a reforming catalyst provided therein for accelerating the reforming reaction of the vaporized fuel to reformed gas, a mixture of reforming catalyst and CO shifting catalyst may be provided. The provision of a mixture of reforming catalyst and CO shifting catalyst makes it possible to eliminate the phenomenon that the yield of carbon monoxide on carbon basis is raised.

(Second Embodiment)

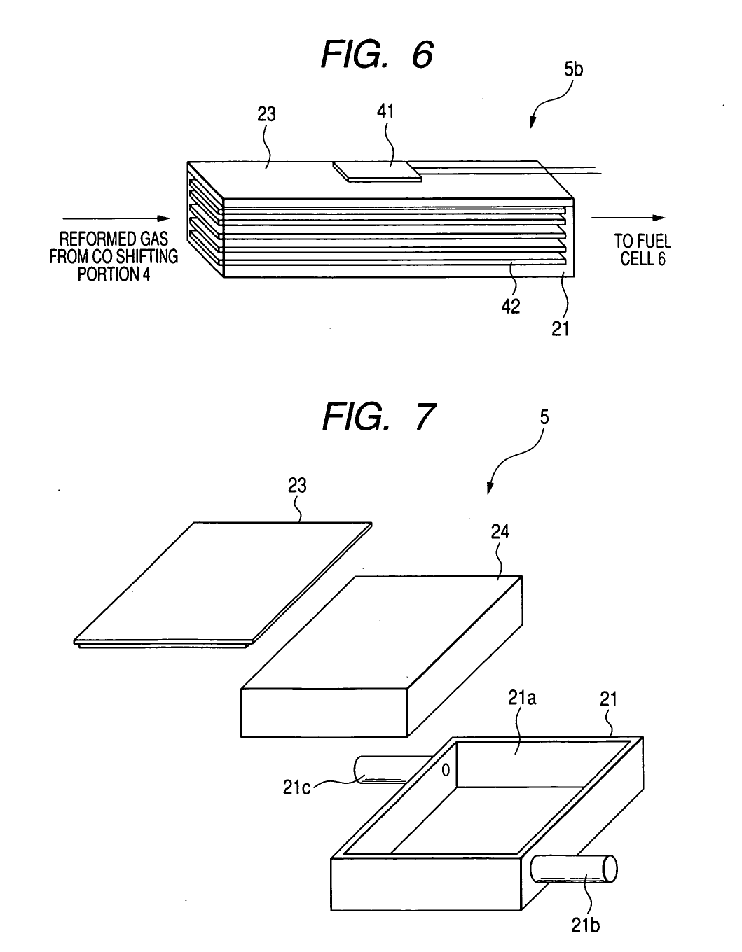

FIG. 6 depicts a second embodiment of the hydrogen generating apparatus and fuel cell system according to the invention. Where the parts are the same as those of the first embodiment shown in FIG. 1, the same reference numerals are used. These parts will not be described.

FIG. 6 depicts a perspective view of the interior of the CO removing portion 5b. The other configurations are the same as those of the first embodiment. The CO removing portion 5b comprises a heater 41 (heating portion) provided therein in addition to the combustion portion 7. The heater 41 may be a cartridge heater having a high resistivity metal wound on an insulating material. The heater 41 receives an external energy, e.g., electric power, if the heater 41 is a cartridge heater. The electric power to be supplied into the heater 41 is supplied, e.g., from the fuel cell 6. When externally supplied with an energy, the heater 41 generates heat to heat the CO removing portion 5.

Inside the vessel 21 are provided a plurality of plate-like catalyst portions 42 (i.e., a plate-type reactor). At least a part of the matrix of the catalyst portion 42 is made of aluminum or an alloy containing aluminum. The catalyst portions 42 are disposed apart from each other in the vessel 21. The catalyst portions 42 are preferably parallel to each other, and an interval between two catalyst portions adjacent to each other preferably is 1 mm or less. In this arrangement, the reformed gas which has been supplied from the CO shifting portion 4 flows through the gap between the vessel 21 or the lid 23 and the catalyst portions 42 or the gap between the juxtaposed catalyst portions 42 until it is discharged to the fuel cell 6.

The catalyst portion 42 includes the catalyst layer 33 provided on the surface thereof, preferably on both surfaces thereof. The catalyst layer 33 is the same as that of the first embodiment and thus will not be further described and shown in FIG. 6.

In accordance with the hydrogen generating apparatus and fuel cell system thus prepared, the concentration of carbon monoxide contained in the reformed gas can be fully reduced by a small-sized CO removing portion 5b. In some detail, the hydrogen generating apparatus and the fuel cell system can be reduced in size without deteriorating the catalyst of the fuel electrode 9 and hence the electricity generating properties.

Further, the selectivity of methanation reaction of carbon monoxide with respect to methanation reaction of carbon dioxide in the CO removing portion 5b is high. Accordingly, the amount of hydrogen to be consumed by the methanation reaction of carbon dioxide during the removal of carbon monoxide in the CO removing portion 5b can be reduced. In other words, the hydrogen generating efficiency of the entire hydrogen generating apparatus can be enhanced to enhance the electricity generating efficiency of the fuel cell system.

Moreover, since the CO removing portion 5b uses methanation reaction to remove carbon monoxide, it is not necessary that oxygen be supplied to the CO removing portion 5b. Accordingly, it is not necessary that the CO removing portion 5b have a unit for supplying oxygen such as pump provided therein. Thus, the hydrogen generating apparatus and the fuel cell system can be reduced in size.

In the case where a fuel containing dimethyl ether is used, even when by-products other than carbon monoxide and carbon dioxide produced with the reforming reaction of unreformed dimethyl ether or dimethyl ether are passed to the CO removing portion, the catalyst layer 33 having ruthenium supported on alumina formed by anodization exhibits a high resistance to these by-products, making it possible to remove carbon monoxide stably over an extended period of time.

Further, the heater 41 provided can be feedback-controlled. Accordingly, the temperature of the CO removing portion 5b can be more accurately controlled, making it possible to further reduce the concentration of carbon monoxide.

Moreover, since the catalyst portion 42 is in sheet form, the catalyst portion 42 can be produced by a small number of working steps, making it possible to reduce the production cost of the hydrogen generating apparatus and the fuel cell system. Further, the sheet-like catalyst portion 42 can be easily combined with a sheet-like member having other catalysts provided thereon. For example, even when the reformed gas contains substances having adverse effects on the catalyst portion 42, a sheet-like member having a catalyst provided thereon for accelerating the conversion of the harmful substances to other harmless substances may be provided in the CO removing portion 5b.

While the foregoing description has been made with reference to the case where the reforming portion 3 has a reforming catalyst provided therein for accelerating the reforming reaction of the vaporized fuel to reformed gas, a mixture of reforming catalyst and CO shifting catalyst may be provided. The provision of a mixture of reforming catalyst and CO shifting catalyst makes it possible to eliminate the phenomenon that the yield of carbon monoxide on carbon basis is raised.

(Third Embodiment)

FIG. 7 depicts a third embodiment of the hydrogen generating apparatus and fuel cell system according to the invention. Where the parts are the same as those of the first embodiment shown in FIG. 1, the same reference numerals are used. These parts will not be described.

FIG. 7 depicts an exploded perspective view of the CO removing portion 5. The CO removing portion 5 comprises a catalyst portion 24 provided therein in place of the catalyst portion 22 according to the first embodiment. The catalyst portion 24 has a catalyst layer 33 provided on the surface of aluminum or alloy containing aluminum having a large number of voids or on the surface of the voids of aluminum or aluminum alloy. The pore of the void preferably is 1 mm or less. As aluminum or aluminum-containing alloy there may be used a porous aluminum material, a aluminum foam or a honeycomb-like aluminum material. The catalyst layer 33 is the same as that of the first embodiment and thus will not be further described and shown in FIG. 7.

The catalyst portion 24 may be made of a spherical, columnar, sheet-like or amorphous (indeterminate form) aluminum or aluminum- containing alloy material. FIG. 7 depicts a rectangular catalyst portion 24 by way of example. The catalyst portion 24 is provided in the fitting portion 21a. The reformed gas which has been supplied into the CO removing portion 5 flows through the voids in the catalyst portion 24 provided in the fitting portion 21a.

In accordance with the hydrogen generating apparatus and fuel cell system thus prepared, the concentration of carbon monoxide contained in the reformed gas can be fully reduced by a small-sized CO removing portion 5. In some detail, the hydrogen generating apparatus and the fuel cell system can be reduced in size without deteriorating the catalyst of the fuel electrode 9 and hence the electricity generating properties.

Further, the selectivity of methanation reaction of carbon monoxide with respect to methanation reaction of carbon dioxide in the CO removing portion 5 is high. Accordingly, the amount of hydrogen to be consumed by the methanation reaction of carbon dioxide during the removal of carbon monoxide in the CO removing portion 5 can be reduced. In other words, the hydrogen generating efficiency of the entire hydrogen generating apparatus can be enhanced to enhance the electricity generating efficiency of the fuel cell system.

Moreover, since the CO removing portion 5 uses methanation reaction to remove carbon monoxide, it is not necessary that oxygen be supplied to the CO removing portion 5. Accordingly, it is not necessary that the CO removing portion 5 have a unit for supplying oxygen such as pump provided therein. Thus, the hydrogen generating apparatus and the fuel cell system can be reduced in size.

In the case where a fuel containing dimethyl ether is used, even when by-products other than carbon monoxide and carbon dioxide produced with the reforming reaction of unreformed dimethyl ether or dimethyl ether are passed to the CO removing portion, the catalyst layer 33 having ruthenium supported on alumina formed by anodization exhibits a high resistance to these by-products, making it possible to remove carbon monoxide stably over an extended period of time.

Moreover, since the catalyst portion 24 has voids, the catalyst portion 24 can be produced by a small number of working steps, making it possible to reduce the production cost of the hydrogen generating apparatus and the fuel cell system. Further, the catalyst portion 24 can be easily combined with a porous member having other catalysts provided thereon. For example, even when the reformed gas contains substances having adverse effects on the catalyst portion 24, a member having a catalyst provided thereon for accelerating the conversion of the harmful substances to other harmless substances may be provided in the CO removing portion 5.

While the foregoing description has been made with reference to the case where the reforming portion 3 has a reforming catalyst provided therein for accelerating the reforming reaction of the vaporized fuel to reformed gas, a mixture of reforming catalyst and CO shifting catalyst may be provided. The provision of a mixture of reforming catalyst and CO shifting catalyst makes it possible to eliminate the phenomenon that the yield of carbon monoxide on carbon basis is raised.

It should not be understood that the description and drawings of the embodiments described in detail above limit the present invention. Those skilled in the art can work out various substitute embodiments, examples and operating techniques from this disclosure. The hydrogen generating apparatus and fuel cell system according to the various embodiments described in detail above can be used for the production of hydrogen and electricity to be used for various purposes. For example, the vaporization portion 2, the CO shifting portion 4 and the CO removing portion 5 may be integrally formed. In this arrangement, the thermal resistance between the vaporization portion 2 and the CO shifting portion 4, between the vaporization portion 2 and the CO removing portion 5 and between the CO shifting portion 4 and the CO removing portion 5 can be lowered to reduce the amount of hydrogen to be combusted in the combustion portion 7. In some detail, the hydrogen generating efficiency of the entire hydrogen generating apparatus can be enhanced to raise the electricity generating efficiency of the fuel cell system.

In the following there will be explained examples of the invention, but the present invention is not limited to such examples unless exceeding the scope of the invention.

### EXAMPLE 1

Using the CO removing portion 5 shown in FIG. 2, carbon monoxide contained in the reformed gas in the hydrogen generating apparatus was removed. The vessel 21, the catalyst portion 22 and the lid 23 were each made of aluminum. A γ-alumina layer was formed on the surface of the catalyst portion 22 to a thickness of 50 μm. Ruthenium was then supported on the γ-alumina layer. The ruthenium source was acetyl acetonate (Ru(C₅H₇O₂)₃). The catalyst portion 22 was dipped in a saturated acetone solution of acetyl acetonate for 24 hours so that it was impregnated with the solution, dried at 120° C., and then calcined at 500° C. to form a catalyst layer 33.

A reformed gas containing hydrogen, carbon monoxide and carbon dioxide was supplied into the CO removing portion 5 to remove carbon monoxide. The temperature of the outer wall of the CO removing portion 5 was controlled to 225° C., 250° C., 275° C. and 300° C. The reformed gases which had been freed of carbon monoxide at the various temperatures were each then subjected to gas chromatography.

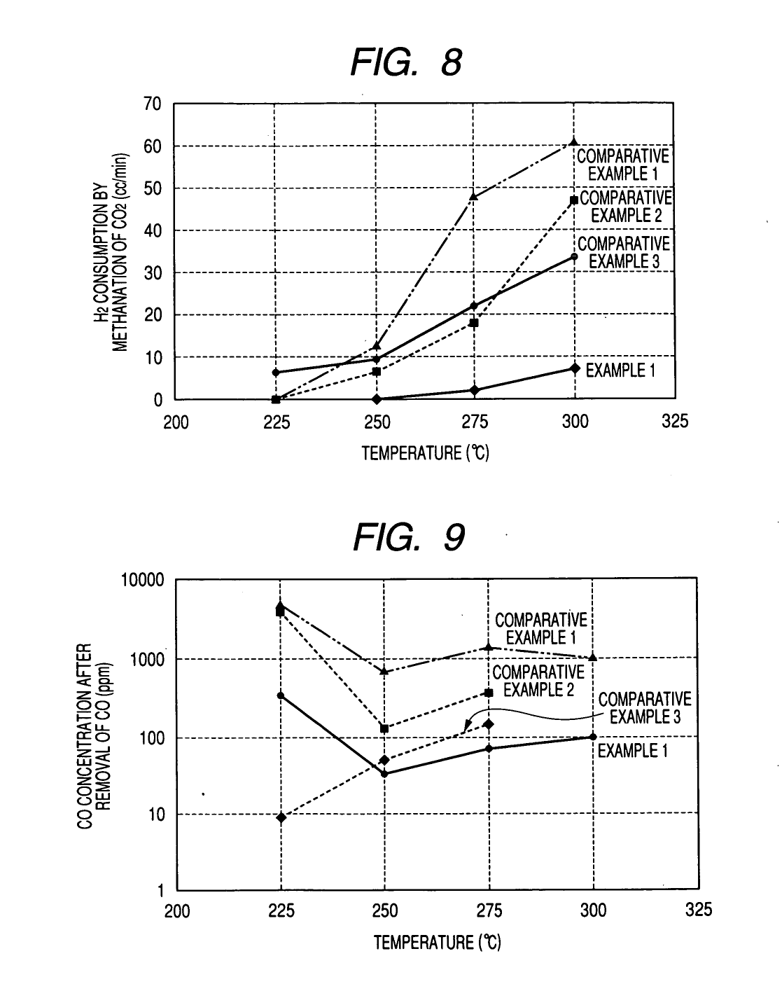

The reformed gas comprised 64.0% of H₂, 20.0% of CO₂, 1.0% of CO, 5.0% of CH₄ and 10.0% of N₂. N₂ is inherently not contained in the reformed gas. For convenience of gas chromatographic analysis of reformed gas, however, N₂ is used as a internal standard substance. The results are shown in FIGS. 8 and 9.

As comparative examples of related art hydrogen generating apparatus, the following three hydrogen generating apparatus were similarly examined.

### COMPARATIVE EXAMPLE 1

A commercially available ruthenium/γ-alumina catalyst was used instead of the catalyst portion 22 shown in Example 1. This catalyst was grained. This grained catalyst was supported on the penetration grooves in an aluminum material having the same shape as that of the catalyst portion 22 by a wash coat method.

### COMPARATIVE EXAMPLE 2

A commercially available ruthenium/γ-alumina catalyst was used instead of the catalyst portion 22 shown in Example 1. This catalyst was the same type as that of Comparative Example 1 but was a product different from that of Comparative Example 1. This catalyst was grained. This grained catalyst was supported on the penetration grooves in an aluminum material having the same shape as that of the catalyst portion 22 by a wash coat method.

### COMPARATIVE EXAMPLE 3

A commercially available ruthenium/zeolite catalyst was used instead of the catalyst portion 24 of Example 3. This catalyst was granular. This catalyst was packed in the fitting portion 21a.

As shown in FIG. 8, all the hydrogen generating apparatus of Comparative Examples 1 to 3 show a rise of the amount of hydrogen consumed by the methanation of carbon dioxide at a temperature of 250° C. or more. On the other hand, it was confirmed that the hydrogen generating apparatus of Example 1 shows a drastically smaller rise of the amount of hydrogen consumed by the methanation of carbon dioxide at a temperature of 250° C. or more than that of Comparative Examples 1 to 3.

Further, as shown in FIG. 9, the hydrogen generating apparatus of Comparative Example 3 can remove carbon monoxide until the concentration of carbon monoxide contained in the reformed gas reaches 100 ppm by mole or less up to 250° C., but the concentration of carbon monoxide contained in the reformed gas is greater than 100 ppm by mole at 275° C. The hydrogen generating apparatus of Comparative Examples 1 and 2 cannot remove carbon monoxide to 100 ppm by mole or less in the reformed gas at all these temperatures. On the other hand, it was confirmed that the hydrogen generating apparatus of Example 3 can remove carbon monoxide to 100 ppm by mole or less in the reformed gas at 250° C. or more.

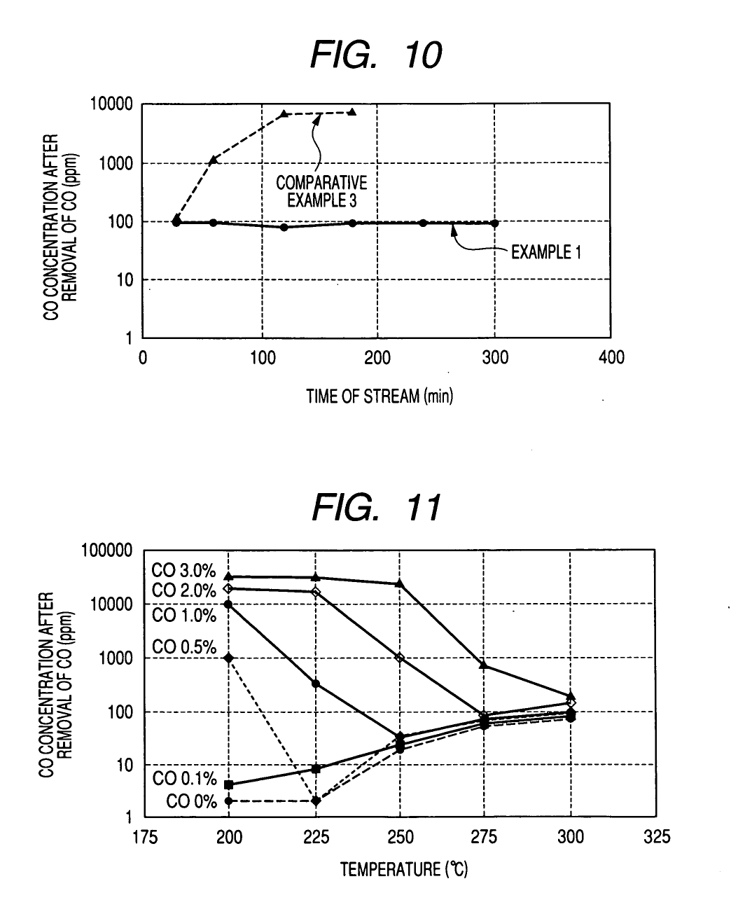

The hydrogen generating apparatus of Example 1 was continuously operated to reform diethyl ether under conditions such that hydrogen is generated at a rate of about 250 cc/min, which corresponds to 20 W output of electricity. The change of the concentration of carbon monoxide after the removal of CO by the CO removing portion 5 is shown in FIG. 10. During this procedure, the molar ratio of dimethyl ether to water was 1:4.

As shown in FIG. 10, the hydrogen generating apparatus of Comparative Example 3 shows a rise of the concentration of carbon monoxide contained in the reformed gas with the elapse of the operating time. On the other hand, it was confirmed that the hydrogen generating apparatus of Example 1 can remove carbon monoxide stably until the concentration of carbon monoxide contained in the reformed gas reaches 100 ppm by mole or less.

### EXAMPLE 2

Carbon monoxide was removed from the reformed gas in the hydrogen generating apparatus using the CO removing portion 5 shown in FIG. 2 in the same manner as in Example 1. The vessel 21, the catalyst portion 22 and the lid 23 were each made of aluminum. A γ-alumina layer was formed on the surface of the catalyst portion 22. Ruthenium was then supported on the γ-alumina layer.

A reformed gas containing hydrogen, carbon monoxide and carbon dioxide was supplied into the CO removing portion 5 to remove carbon monoxide. The temperature of the outer wall of the CO removing portion 5 was controlled to 225° C., 250° C., 275° C. and 300° C. The reformed gases which had been freed of carbon monoxide at the various temperatures were each then subjected to gas chromatography.

The reformed gas comprised 65% of H₂+CO, 20% of CO₂, 5% of CH₄ and 10% of N₂. The composition ratio of H₂ to CO varied as follows. H₂=62.0%/CO=3.0%, H₂=64.0%/CO=1.0%, H₂=64.5%/CO=0.5%, H₂=65.0%/CO=0%. These reformed gases were supplied. These reformed gases which had been freed of carbon monoxide were each then subjected to gas chromatography. N₂ is inherently not contained in the reformed gas. For convenience of gas chromatographic analysis of reformed gas, however, N₂ is used as a internal standard substance. The results are shown in FIG. 11.

As shown in FIG. 11, all the hydrogen generating apparatus into which a reformed gas having a carbon monoxide concentration of 1.0% or less had been supplied were able to remove carbon monoxide to a concentration of 100 ppm or less at 250° C. or more. On the other hand, the hydrogen generating apparatus into which a reformed gas having a carbon monoxide concentration of 2.0% or 3.0% had been supplied were able to remove carbon monoxide to a concentration of about 100 ppm at 300° C. but to as low a concentration as about 100 ppm at 250° C.

What is claimed is:

1. A CO removing apparatus comprising:
a CO removing portion that removes at least a part of carbon monoxide from a gas containing: carbon monoxide; carbon dioxide; and hydrogen, by accelerating the methanation reaction of the at least a part of the carbon monoxide;
a catalyst portion in the CO removing portion, the catalyst portion having a surface of one of aluminum and an alloy containing aluminum, the catalyst portion including a catalyst layer containing ruthenium supported by an alumina, the alumina being produced by an anodization of at least a part of the surface; and
a heating portion that heats the catalyst portion to a temperature of 250° C. or more.

2. The CO removing apparatus according to claim 1, wherein the catalyst portion has a plurality of penetration grooves, a width between two penetration grooves adjacent to each other is 1 mm or less, and the catalyst layer is provided in the surface of the penetration grooves.

3. The CO removing apparatus according to claim 1, wherein the catalyst layer is a catalyst layer containing ruthenium supported by γ-alumina having an average pore diameter of 5 to 10 nm.

4. The CO removing apparatus according to claim 1, wherein the gas has a concentration of carbon monoxide of 1.0 mol-% or less before the at least a part of carbon monoxide is removed in the CO removing portion.

5. The CO removing apparatus according to claim 1, wherein the CO removing portion comprises a plurality of plate-like catalyst portions parallel to each other, and an interval between two catalyst portions adjacent to each other is 1 mm or less.

6. The CO removing apparatus according to claim 1, wherein the catalyst portion comprises one of aluminum and an alloy containing aluminum, the aluminum and the alloy having a large number of voids.

7. A method for producing a CO removing apparatus, the CO removing apparatus comprising:
a CO removing portion that removes at least a part of carbon monoxide from a gas containing: carbon monoxide; carbon dioxide; and hydrogen, by accelerating the methanation reaction of the at least a part of the carbon monoxide;
a catalyst portion in the CO removing portion, the catalyst portion having a surface of one of aluminum and an alloy containing aluminum, the catalyst portion including a catalyst layer containing ruthenium supported by an alumina, the alumina being produced by an anodization of at least a part of the surface; and
a heating portion that heats the catalyst portion to a temperature of 250° C. or more,
the method comprising:
anodizing the one of aluminum and an alloy containing aluminum in the catalyst portion to form the alumina; and
impregnating the alumina with the ruthenium using an organic salt of ruthenium and an organic solvent to form the catalyst layer.

8. The method for producing a CO removing apparatus according to claim 7, wherein the organic salt is ruthenium acetyl acetonate.

9. The method for producing a CO removing apparatus according to claim 7, wherein the organic solvent is at least one of acetone, acetylacetone and tetrahydrofurane.

10. A method for removing CO with a CO removing apparatus, the CO removing apparatus comprising:
a CO removing portion that removes at least a part of carbon monoxide from a gas containing: carbon monoxide; carbon dioxide; and hydrogen, by accelerating the methanation reaction of the at least a part of the carbon monoxide; and
a catalyst portion in the CO removing portion, the catalyst portion having a surface of one of aluminum and an alloy containing aluminum, the catalyst portion including a catalyst layer containing ruthenium supported by an alumina, the alumina being produced by an anodization of at least a part of the surface,
the method comprising heating the catalyst portion to a temperature of 250° C. or more.

11. The method for removing CO according to claim 10, wherein the gas has a concentration of carbon monoxide of 1.0 mol-% or less before the at least a part of carbon monoxide is removed in the CO removing portion.

12. A hydrogen generating apparatus comprising:
a reforming portion that obtains a reformed gas containing hydrogen from a fuel containing: an organic compound containing carbon; hydrogen; and water; and
a CO removing apparatus according to claim 1, the CO removing apparatus removing carbon monoxide from the reformed gas.

13. A fuel cell system comprising:
a reforming portion that obtains a reformed gas containing hydrogen from a fuel containing: an organic compound containing carbon; hydrogen; and water;
a CO removing apparatus according to claim 1, the CO removing apparatus removing carbon monoxide from the reformed gas; and
a fuel cell that generates electricity from the hydrogen in the reformed gas and oxygen in the atmosphere.

14. The fuel cell system according to claim 13, wherein the organic compound includes dimethyl ether.
